(19) United States
(12) Patent Application Publication
(10) Pub. No.: US 2022/0136544 A1
(43) Pub. Date: May 5, 2022

(54) STRETCHABLE ROD STRUCTURE AND METHOD OF MOUNTING THE SAME ON OBJECT

(71) Applicant: TING-JUI WANG, New Taipei City (TW)

(72) Inventor: TING-JUI WANG, New Taipei City (TW)

(21) Appl. No.: 17/472,716

(22) Filed: Sep. 13, 2021

(30) Foreign Application Priority Data
Nov. 5, 2020 (TW) 109138597

(51) Int. Cl. F16B 7/10; F16B 9/00

(52) U.S. Cl. CPC F16B 7/10; F16B 9/056; F16B 9/01

(57) ABSTRACT

A stretchable rod structure and a method of mounting the same on an object are introduced. The stretchable rod structure has a fitting member and a rod member. The fitting member has a first fitting portion or first abutting portion. The first fitting portion or first abutting portion is adapted to fit to or abut against a first object. The rod member is movably fitted to the fitting member. The rod member has a second fitting portion or second abutting portion. The second fitting portion or second abutting portion is adapted to fit to or abut against a second object. Therefore, the stretchable rod structure can be fitted to the first object and the second object, thereby allowing two objects to be fitted together, moved or separated.

### CROSS-REFERENCE TO RELATED APPLICATION

This non-provisional application claims priority under 35 U.S.C. § 119(a) on Patent Application No(s). 109138597 filed in Taiwan, R.O.C. on Nov. 5, 2020, the entire contents of which are hereby incorporated by reference.

### BACKGROUND OF THE INVENTION

### 1. Field of the Invention

The present disclosure relates to a stretchable rod structure and a method of mounting the same on an object, and in particular to a stretchable rod structure and a method of mounting the same on an object, adapted to fit together, move or separate two objects.

### 2. Description of the Related Art

Conventionally, fitting together at least two first objects usually involves fastening them together with screws or fasteners.

Although the aforesaid conventional technique is effective in fitting together the two first objects, thereafter the two first objects cannot be moved or separated, rendering the screws or fasteners useless to meet practical operation needs.

### BRIEF SUMMARY OF THE INVENTION

An objective of the present disclosure is to provide, in at least one embodiment of the present disclosure, a stretchable rod structure and a method of mounting the same on an object, to fit the stretchable rod structure to a first object and a second object, so as to fit together, move or separate the two objects.

To achieve at least the above objective, the present disclosure provides a stretchable rod structure, comprising a fitting member and a rod member. The fitting member has a first fitting portion or a first abutting portion. The first fitting portion or the first abutting portion is adapted to fit to or abut against a first object. The rod member and the fitting member are movably fitted together. The rod member has a second fitting portion or a second abutting portion. The second fitting portion or the second abutting portion is adapted to fit to or abut against the second object.

The present disclosure further provides a stretchable rod structure which comprises a fitting member and a rod member. The fitting member has a first fitting portion or a first abutting portion. The rod member and the fitting member are movably fitted together. The rod member has a second fitting portion or a second abutting portion.

The present disclosure further provides a method of mounting a stretchable rod structure on an object. The method comprises: lifting a first fitting portion out of a carrier with a tool, comparing, with a comparison device, the first fitting portion with a first object to identify a position thereof, placing the first fitting portion on the first object with the tool, welding, riveting, expandedly connecting or fastening the first fitting portion to the first object, then fitting to the first fitting portion both a fitting member and a rod member which are capable of movably fitting.

The present disclosure further provides a method of mounting a stretchable rod structure on an object. The method comprises: lifting the stretchable rod structure or a first fitting portion thereof with a tool, comparing, with a comparison device, the stretchable rod structure or the first fitting portion with a first object to identify a position thereof, and placing the stretchable rod structure or the first fitting portion on the first object with the tool so as to weld, rivet, expandedly connect or fasten the stretchable rod structure or the first fitting portion to the first object, wherein the stretchable rod structure has a fitting member and a rod member which are adapted for movably fitting.

The present disclosure further provides a method of mounting a stretchable rod structure on an object. The method comprises: lifting the stretchable rod structure or a first fitting portion thereof with a tool, placing the stretchable rod structure or the first fitting portion on the first object with the tool so as to weld, rivet, expandedly connect or fasten the stretchable rod structure or the first fitting portion to the first object, wherein the stretchable rod structure has a fitting member and a rod member which are adapted for movably fitting.

Optionally, the stretchable rod structure further comprises a resilient component with two ends abutting against the fitting member and the rod member, respectively, or against the first fitting portion and the fitting member or the rod member, respectively.

Optionally, the resilient component is a spring, tension spring, torsional spring, leaf spring or resilient post.

Optionally, a first angle and a second angle are defined between the fitting member and the first object, with the first angle being greater than the second angle, such that the stretchable rod structure moves obliquely to stretch.

Optionally, a first angle and a second angle are defined between the fitting member and the first object. The first angle is greater than 90°, and the second angle is less than 90°; thus, the stretchable rod structure obliquely drives the second object to move, stretchable or retract.

Optionally, the first fitting portion or the second fitting portion fits to the fitting member or the rod member through the fitting member.

Optionally, the first fitting portion or the second fitting portion undergoes fitting through the fitting member, such that the fitting member or the rod member forms a movable joint structure.

Optionally, the fitting member or the rod member undergoes fitting through the fitting member to form a joint structure.

Optionally, the first abutting portion and the second abutting portion are movably fitted together.

Optionally, the first fitting portion or the second fitting portion has a material storage space. When compressed under an applied force, material of the first object flows into or enters the material storage space, such that the first fitting portion or the second fitting portion fits to the first object.

Optionally, the first fitting portion or the second fitting portion has an expanded connection structure. When the expanded connection structure is compressed under an applied force, the first fitting portion or the second fitting portion is expandedly connected to the first object.

Optionally, the fitting member fits to the first object, and the rod member fits to or abuts against the second object, with the second object movably fitted to the third object. Therefore, when stretched, the second object undergoes rotational movement together with the third object.

Optionally, the fitting member has a non-right-angle fitting surface adapted to fit to the first fitting portion.

Optionally, two edges of the non-right-angle fitting surface have a first angle and a second angle, respectively, with the first angle being greater than the second angle.

Optionally, two edges of the non-right-angle fitting surface have a first angle and a second angle, respectively, with the first angle being greater than 90°, the second angle being less than 90°, so as to attain an oblique movement direction.

Optionally, the fitting member has a non-right-angle fitting surface adapted to be fitted to the first object.

Optionally, two edges of the non-right-angle fitting surface have a first angle and a second angle, respectively, with the first angle being greater than the second angle.

Optionally, two edges of the non-right-angle fitting surface have a first angle and a second angle, respectively, with the first angle being greater than 90°, the second angle being less than 90°, so as to attain an oblique movement direction.

Optionally, the first object has a fitting portion, whereas the fitting portion of the first object and the first fitting portion of the fitting member are fitted together.

Optionally, the first object has a fitting portion, and the fitting portion of the first object is fitted to the first fitting portion of the fitting member through the fitting member.

Optionally, the fitting member is laterally movably fitted to the rod member.

Optionally, the fitting member is laterally movably fitted to the rod member, and the rod member is parallel or substantially parallel to the first object.

Optionally, the fitting member is laterally movably fitted to the rod member, wherein the fitting member and the first object are fitted together vertically or substantially vertically.

Optionally, the fitting member has a positioning portion for positioning an angle or a movement angle of the fitting member or the rod member.

Optionally, the fitting member has a positioning portion, and the first object has a corresponding positioning portion, wherein the positioning portion and the corresponding positioning portion prevent rotation of each other or limit displacement of each other.

Optionally, the fitting member or the rod member is rod-shaped or block-shaped or is a casing, pored member, slot, groove, bump member, fastener, hook, disk-shaped member, strip-shaped member, cylinder-shaped member, barrel-shaped member or pipe-shaped member.

Optionally, the fitting member has a mounting portion aligned vertically or laterally, and the rod member is mounted on the mounting portion in order to move or retract.

Optionally, the mounting portion is a hole portion, pipe portion, slot portion, groove portion, barrel portion, cylinder portion, step portion or dent portion.

### BRIEF DESCRIPTION OF THE DRAWINGS

FIG. 1 is a schematic view of a stretchable rod structure according to the first embodiment of the present disclosure.

FIG. 2 is an exploded view of the stretchable rod structure according to the second embodiment of the present disclosure.

FIG. 3 is a schematic view of the assembled stretchable rod structure according to the second embodiment of the present disclosure.

FIG. 4 is a schematic view 1 of how to operate the stretchable rod structure according to the second embodiment of the present disclosure.

FIG. 5 is a schematic view 2 of how to operate the stretchable rod structure according to the second embodiment of the present disclosure.

FIG. 6 is a schematic view of the stretchable rod structure according to the third embodiment of the present disclosure.

FIG. 7 is a schematic view of how to operate the stretchable rod structure according to the fourth embodiment of the present disclosure.

FIG. 8 is a schematic view of how to operate the stretchable rod structure according to the fifth embodiment of the present disclosure.

FIG. 9 is a schematic view of the stretchable rod structure according to the sixth, seventh and eighth embodiment of the present disclosure.

FIG. 10 is a schematic view of how to operate the stretchable rod structure according to the ninth embodiment of the present disclosure.

FIG. 11 is a schematic view of how to operate the stretchable rod structure according to the tenth embodiment of the present disclosure.

FIG. 12 is an exploded view of the stretchable rod structure according to the 11th embodiment of the present disclosure.

FIG. 13 is an exploded view of the stretchable rod structure according to the 12th embodiment of the present disclosure.

FIG. 14 is a schematic view of the assembled stretchable rod structure according to the 12th embodiment of the present disclosure.

FIG. 15 is a schematic view of how to operate the stretchable rod structure according to the 13th embodiment of the present disclosure.

FIG. 16 is a schematic view of how to operate the stretchable rod structure according to the 14th embodiment of the present disclosure.

FIG. 17 is a schematic view of how to operate the stretchable rod structure according to the 15th embodiment of the present disclosure.

FIG. 18 is a perspective view of the stretchable rod structure according to the 16th embodiment of the present disclosure.

FIG. 19 is a schematic view of how to operate the stretchable rod structure according to the 16th embodiment of the present disclosure.

FIG. 20 is a schematic view of how to operate the stretchable rod structure according to the 17th embodiment of the present disclosure.

FIG. 21 is a schematic view of how to operate the stretchable rod structure according to the 18th embodiment of the present disclosure.

FIG. 22 is a schematic view of how to operate the stretchable rod structure according to the 19th embodiment of the present disclosure.

FIG. 23 is a schematic view of how to operate the stretchable rod structure according to the 20th embodiment of the present disclosure.

FIG. 24 is a schematic view of how to operate the stretchable rod structure according to the 21st embodiment of the present disclosure.

FIG. 25 is a schematic view of how to operate the stretchable rod structure according to the 22nd embodiment of the present disclosure.

FIG. 26 is a schematic view of the assembled stretchable rod structure of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

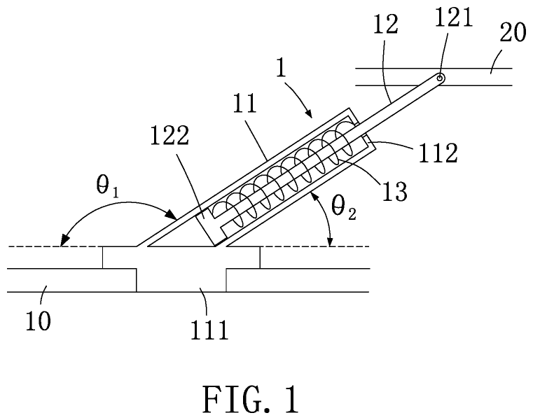

Referring to FIG. 1, the present disclosure provides a stretchable rod structure and a method of mounting the same on an object. The stretchable rod structure 1 comprises a fitting member 11 and a rod member 12.

The fitting member 11 has a first fitting portion 111 or a first abutting portion 112. The first fitting portion 111 or the first abutting portion 112 is adapted to fit to or abut against the first object 10.

The rod member 12 and the fitting member 11 are movably fitted together. The rod member 12 has a second fitting portion 121 or second abutting portion 122. The second fitting portion 121 or the second abutting portion 122 is adapted to fit to or abut against the second object 20.

Regarding the stretchable rod structure 1 in an embodiment of the present disclosure, the fitting member 11 has the first fitting portion 111 and the first abutting portion 112, and the rod member 12 has the second fitting portion 121 and the second abutting portion 122. The rod member 12 and the fitting member 11 are movably fitted together; thus, the first abutting portion 112 and the second abutting portion 122 are movably fitted together. When the fitting member 11 moves to a predetermined position, the first abutting portion 112 and the second abutting portion 122 together attain abutting. The first fitting portion 111 fits to the first object 10. The second fitting portion 121 fits to the second object 20.

To start working, an applied force is applied to the second object 20, such that the second object 20 moves away from the first object 10; meanwhile, the fitting member 11 is stationary. Thus, the second object 20 drives the rod member 12 to move within the fitting member 11. When the fitting member 11 moves to a predetermined position, the first abutting portion 112 and the second abutting portion 122 together attain abutting. Therefore, the stretchable rod structure 1 is fitted to the first object 10 and the second object 20, allowing two objects to fit together, move or separate.

The stretchable rod structure 1 in an embodiment of the present disclosure further comprises a resilient component 13. Two ends of the resilient component 13 abut against the fitting member 11 and the rod member 12, respectively, or against the first fitting portion 111 and the fitting member 11 or the rod member 12, respectively. The resilient component 13 is a spring, tension spring, torsional spring, leaf spring or resilient post. In this embodiment, one end of the resilient component 13 abuts against the first abutting portion 112, and the other end of the resilient component 13 abuts against the second abutting portion 122. Therefore, when the second object 20 drives the rod member 12 to move within the fitting member 11, the resilient component 13 is compressed or released, such that the rod member 12 is capable of automatic restoration to facilitate operation and usage.

In an embodiment of the present disclosure, a first angle θ1 and a second angle θ2 are defined between the fitting member 11 and the first object 10. The first angle θ1 is greater than the second angle θ2, such that the stretchable rod structure 1 moves obliquely to stretch.

In an embodiment of the present disclosure, a first angle θ1 and a second angle θ2 are defined between the fitting member 11 and the first object 10. The first angle θ1 is greater than 90°, and the second angle θ2 is less than 90°, such that the stretchable rod structure 1 obliquely drives the second object 20 to move, stretch or retract.

In an embodiment of the present disclosure, the fitting member 11 or the rod member 12 is rod-shaped or block-shaped, or is a casing, pored member, slot, groove, bump member, fastener, hook, disk-shaped member, strip-shaped member, cylinder-shaped member, barrel-shaped member or pipe-shaped member. Therefore, the fitting member 11 or the rod member 12 of different forms can be in use to meet practical operation needs, such that the fitting member 11 and the rod member 12 meet practical operation needs.

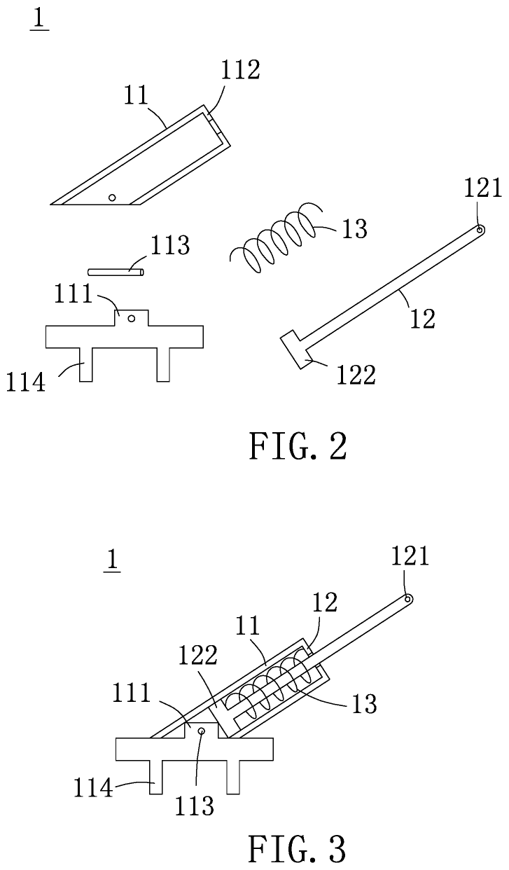

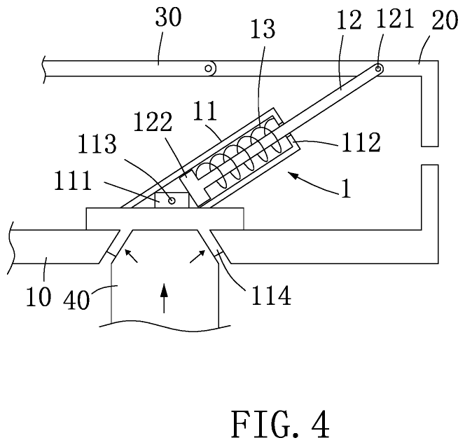

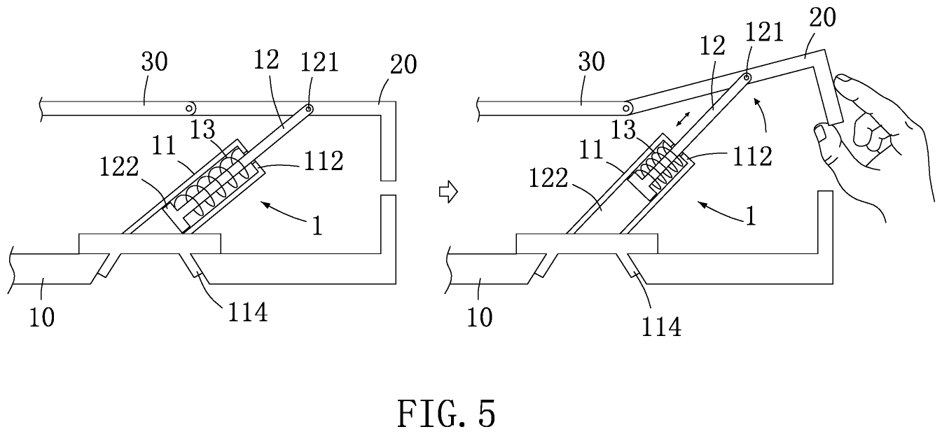

Referring to FIG. 2 through FIG. 5, this embodiment is distinguished from the aforesaid embodiment by the technical feature described below. The first fitting portion 111 is fitted to the fitting member 11 through the fitting member 113. In this embodiment, the first fitting portion 111 has an expanded connection structure 114 which, when compressed under an applied force exerted by a tool 40, causes the first fitting portion 111 to be expandedly connected to the first object 10. One end of the resilient component 13 abuts against the first abutting portion 112. The other end of the resilient component 13 abuts against the second abutting portion 122. Alternatively, the second fitting portion 121 is fitted to the rod member 12 through a fitting member. The second fitting portion has an expanded connection structure which, when compressed under an applied force, causes the second fitting portion to be expandedly connected to the first object 10 or the second object 20 (not shown).

To start working, the fitting member 11 fits to the first object 10, whereas the rod member 12 fits to the second object 20. The second object 20 is movably fitted to the third object 30. When an applied force is applied to the second object 20, the second object 20 moves away from the first object 10 and compresses the resilient component 13; meanwhile, the fitting member 11 is stationary, such that the second object 20 drives the rod member 12 to move within the fitting member 11. Thus, when stretched, the second object 20 undergoes rotational movement together with the third object 30. When the fitting member 11 moves to a predetermined position, the first abutting portion 112 of the fitting member 11 abuts against the second abutting portion 122. When applied forces are no longer applied to the second object 20, the resilient component 13 is released and thus drives the rod member 12, such that the rod member 12 drives the second object 20 to move toward the first object 10. Therefore, the stretchable rod structure 1 is fitted to the first object 10 and the second object 20, allowing two objects to fit together, move or separate.

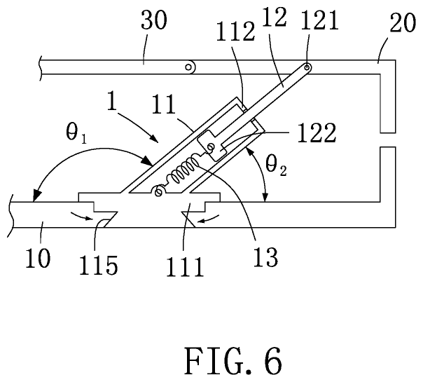

Referring to FIG. 6, this embodiment is distinguished from the aforesaid embodiment by the technical feature described below. The first fitting portion 111 has a material storage space 115. When the material storage space 115 is compressed under an applied force, the material of the first object 10 flows into or enters the material storage space 115, such that the first fitting portion 111 fits to the first object 10. In this embodiment, the resilient component 13 is a tension spring, and two ends of the resilient component 13 are disposed at the first fitting portion 111 and the second abutting portion 122, respectively. Therefore, when an applied force is applied to the second object 20, the second object 20 moves away from the first object 10 and compresses the resilient component 13; meanwhile, the fitting member 11 is stationary, such that the second object 20 drives the rod member 12 to move within the fitting member 11. Thus, when the second object 20 is stretched, the second object 20 undergoes rotational movement together with the third object 30. When the fitting member 11 moves to a predetermined position, the first abutting portion 112 and the second abutting portion 122 together attain abutting. When applied forces are no longer applied to the second object 20, the resilient component 13 is released and drives the rod member 12, such that the rod member 12 drives the second object 20 to move toward the first object 10. Therefore, the stretchable rod structure 1 is fitted to the first object 10 and the second object 20, allowing two objects to fit together, move or separate.

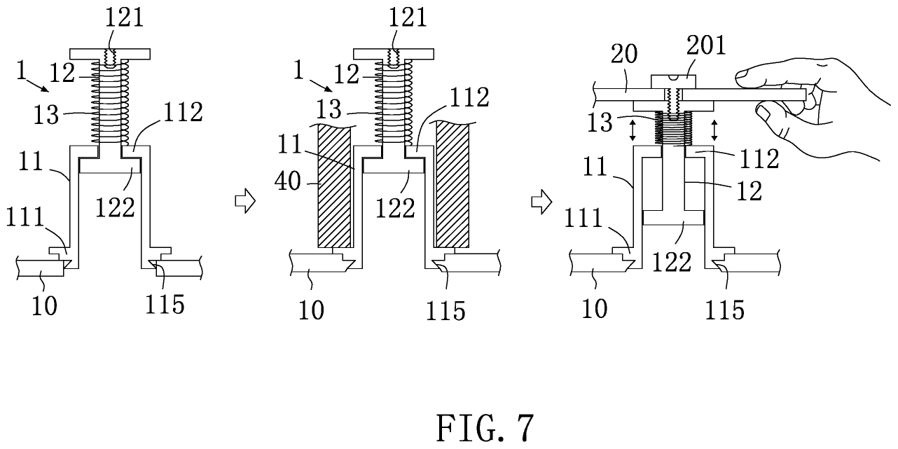

Referring to FIG. 7, this embodiment is distinguished from the aforesaid embodiment by the technical feature described below. The first fitting portion 111 has a material storage space 115. When the material storage space 115 is compressed under an applied force exerted by the tool 40, material of the first object 10 flows into or enters the material storage space 115, such that the first fitting portion 111 fits to the first object 10, allowing the second fitting portion 121 to fit to the second object 20 in the presence of a fitting element 201 thereof. In this embodiment, the resilient component 13 has one end abutting against the first abutting portion 112 and the other end abutting against the second fitting portion 121. The fitting member 11 is vertically disposed on the first object 10. Therefore, the second object 20 moves, under an applied force applied thereto, toward the first object 10 and compresses the resilient component 13, or the applied force is no longer applied to the second object 20. Thus, the resilient component 13 is released, and the rod member 12 drives the second object 20 to move away from the first object 10, allowing the stretchable rod structure 1 to vertically drive the second object 20 to move, stretch or retract.

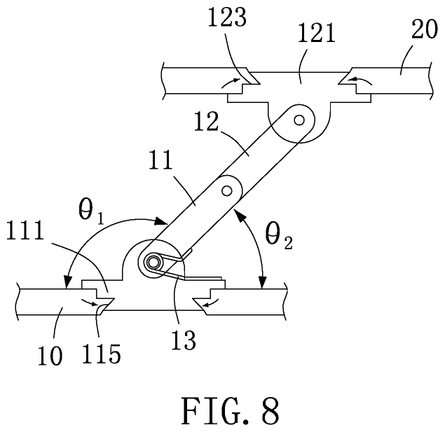

Referring to FIG. 8, this embodiment is distinguished from the aforesaid embodiment by the technical feature described below. The first fitting portion 111 of the fitting member 11 and the second fitting portion 121 of the rod member 12 are fitted together by the fitting member 113, such that the stretchable rod structure 1 forms a movable joint structure through the fitting member 11 and the rod member 12. The first fitting portion 111 and the second fitting portion 121 have material storage spaces 115, 123, respectively. Under an applied force, materials of the first object 10 and the second object 20 flow into or enter the material storage spaces 115, 123, respectively; thus, the first fitting portion 111 and the second fitting portion 121 are fitted to the first object 10 and the second object 20, respectively. The resilient component 13 is a torsional spring, and two ends of the resilient component 13 abut against the first fitting portion 111 and the fitting member 11, respectively.

Therefore, an applied force is applied to the second object 20, such that the stretchable rod structure 1 in the form of the joint structure turns and thus allows the second object 20 to move toward or away from the first object 10; meanwhile, the movement of the second object 20 is accompanied by compression or release of the resilient component 13, such that the fitting member 11 is capable of automatic restoration and capable of driving the rod member 12. After that, the rod member 12 pushes the second object 20 to facilitate operation, such that the stretchable rod structure 1 in the form of the joint structure is fitted to the first object 10 and the second object 20, allowing two objects to fit together, move or separate.

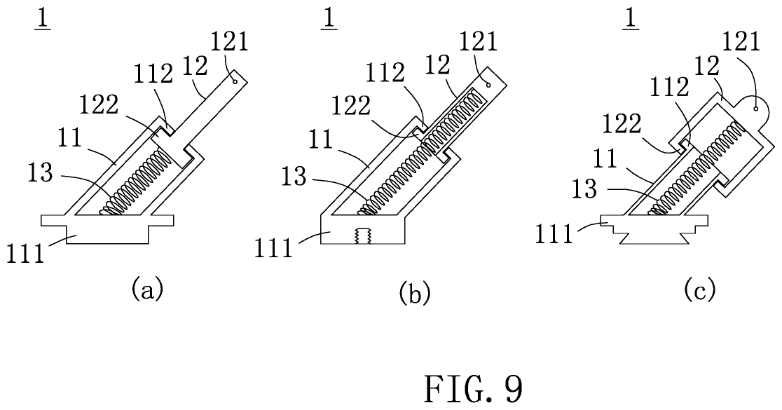

Referring to FIG. 9, this embodiment is distinguished from the aforesaid embodiment by the technical feature described below. The first fitting portion 111 of the fitting member 11 of the stretchable rod structure 1 is portion a, portion b or portion c shown in FIG. 9, and two ends of the resilient component 13 abut against the first fitting portion 111 and the rod member 12, respectively. Therefore, the first fitting portion 111 of different forms can be fitted to the first object 10. Therefore, the present disclosure further meets practical operation needs.

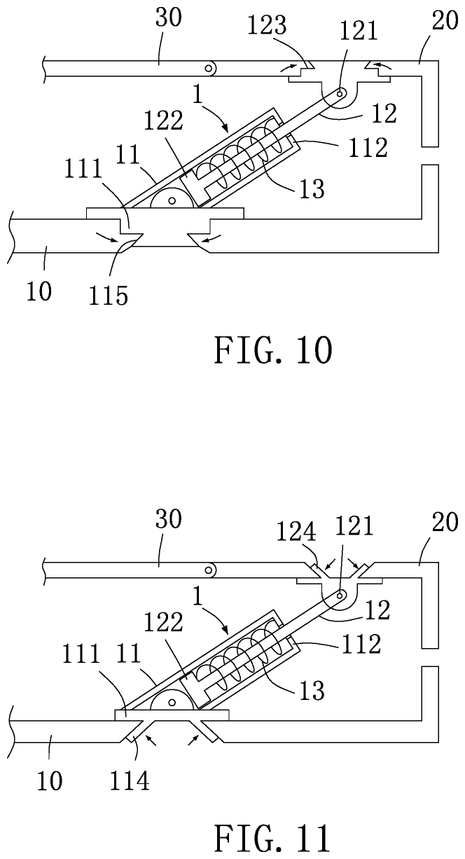

Referring to FIG. 10, this embodiment is distinguished from the aforesaid embodiment by the technical feature described below. The first fitting portion 111 and the second fitting portion 121 have material storage spaces 115, 123, respectively, which, when compressed under an applied force, cause materials of the first object 10 and the second object 20 to flow into or enter the material storage spaces 115, 123, such that the first fitting portion 111 and the second fitting portion 121 are fitted to the first object 10 and the second object 20, respectively, and the second object 20 is movably fitted to a third object 30; meanwhile, the resilient component 13 has one end abutting against the first abutting portion 112 and the other end abutting against the second abutting portion 122.

Therefore, when an applied force is applied to the second object 20, the second object 20 moves away from the first object 10 and compresses the resilient component 13; meanwhile, the fitting member 11 is stationary, such that the second object 20 drives the rod member 12 to move within the fitting member 11. Therefore, when the second object 20 is stretched, the second object 20 undergoes rotational movement together with the third object 30. When the fitting member 11 moves to a predetermined position, the first abutting portion 112 and the second abutting portion 122 together attain abutting When applied forces are no longer applied to the second object 20, the resilient component 13 is released and drives the rod member 12, such that the rod member 12 drives the second object 20 to move toward the first object 10. Therefore, the stretchable rod structure 1 is fitted to the first object 10 and the second object 20, allowing two objects to fit together, move or separate.

Referring to FIG. 11, this embodiment is distinguished from the aforesaid embodiment by the technical feature described below. The first fitting portion 111 and the second fitting portion 121 have expanded connection structures 114, 124, respectively. An applied force is applied to the expanded connection structures 114, 124, such that the first fitting portion 111 and the second fitting portion 121 are expandedly connected to the first object 10 and the second object 20, respectively, whereas the resilient component 13 has one end abutting against the first abutting portion 112 and the other end abutting against the second abutting portion 122.

Therefore, an applied force is applied to the second object 20 to cause the second object 20 to move away from the first object 10 and compress the resilient component 13; meanwhile, the fitting member 11 is stationary, such that the second object 20 drives the rod member 12 to move within the fitting member 11, and the second object 20 undergoes stretching movement. When the fitting member 11 moves to a predetermined position, the first abutting portion 112 and the second abutting portion 122 together attain abutting When applied forces are no longer applied to the second object 20, the resilient component 13 is released and drives the rod member 12, such that the rod member 12 drives the second object 20 to move toward the first object 10. Therefore, the stretchable rod structure 1 is fitted to the first object 10 and the second object 20, allowing two objects to fit together, move or separate.

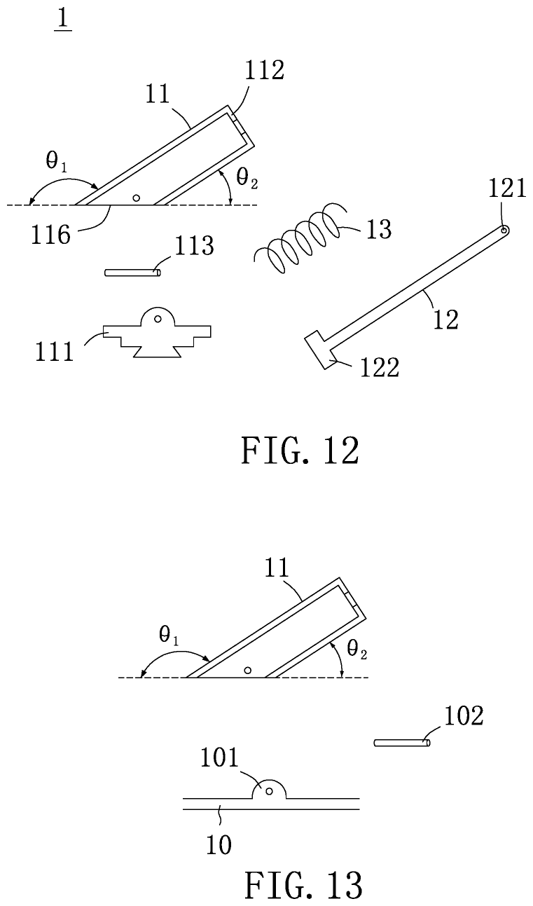

Referring to FIG. 12, this embodiment is distinguished from the aforesaid embodiment by the technical feature described below. The fitting member 11 has a non-right-angle fitting surface 116 adapted to be fitted to the first fitting portion 111. The two edges of the non-right-angle fitting surface 116 have a first angle θ1 and a second angle θ2, respectively. The first angle θ1 is greater than the second angle θ2. The first angle θ1 is greater than 90°, and the second angle θ2 is less than 90°, such that the fitting member 11 stops the rod member 12 from tilting, so as to attain an oblique movement direction, allowing the stretchable rod structure 1 to obliquely drive the second object to move, stretch or retract.

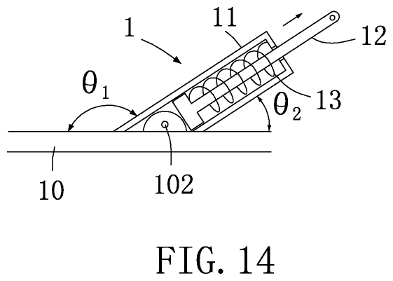

Referring to FIG. 13 and FIG. 14, this embodiment is distinguished from the aforesaid embodiment by the technical feature described below. The first object 10 has a fitting portion 101. The fitting portion 101 is fitted to the first fitting portion 111 of the fitting member 11 through the fitting member 102. Therefore, the stretchable rod structure 1 can be fitted to the first object 10 to meet different needs.

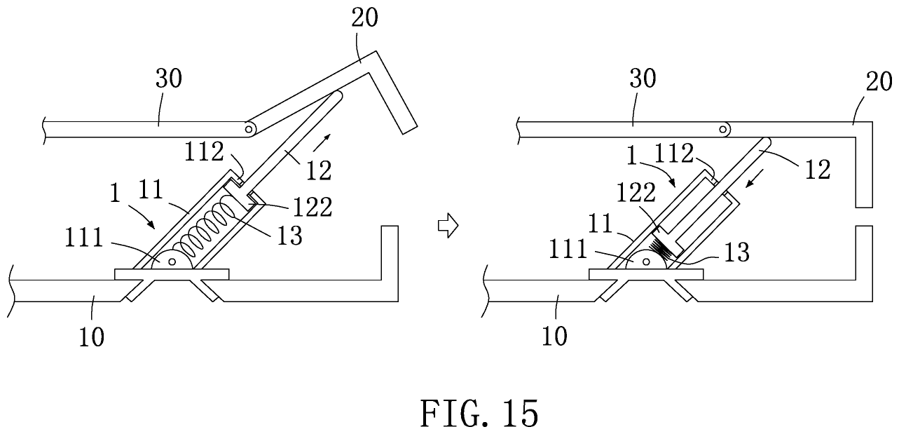

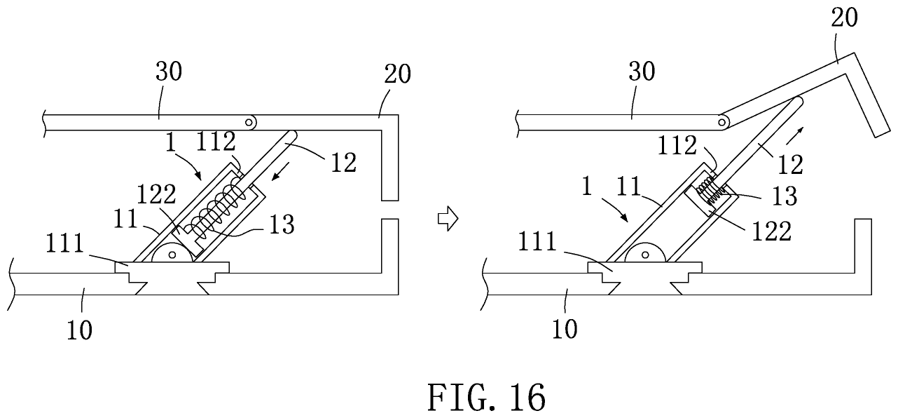

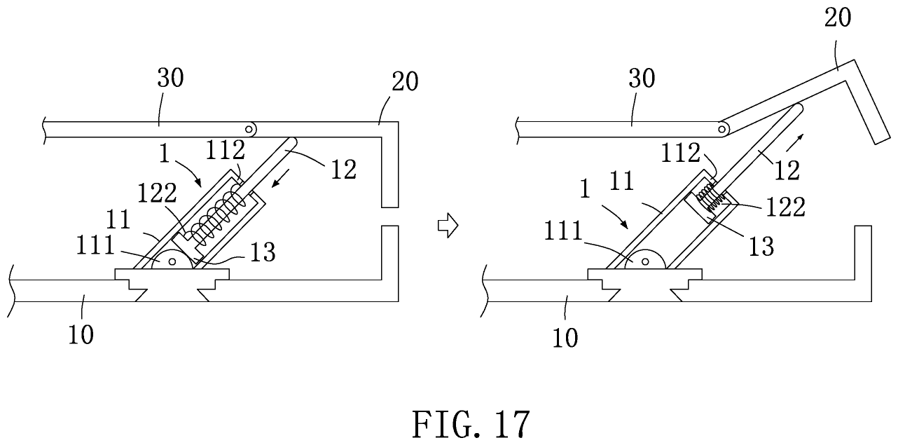

Referring to FIG. 15 through FIG. 17, this embodiment is distinguished from the aforesaid embodiment by the technical feature described below. The expanded connection shown in FIG. 15, the riveting depicted by FIG. 16 and achieved by material entry or inflow, or fitting the fitting member 102 and the first fitting portion 111 together as shown in FIG. 17 enables the first fitting portion 111 of the fitting member 11 of the stretchable rod structure 1 to fit to the first object 10, enables the second fitting portion 121 of the rod member 12 to abut against the second object 20, enables the second object 20 to movably fit to the third object 30, enables the two ends of the resilient component 13 to abut against the first fitting portion 111 and the second abutting portion 122 respectively (as shown in FIG. 15), enables the two ends of the resilient component 13 to abut against the first abutting portion 112 and the second abutting portion 122 respectively (as shown in FIG. 16), or enables the two ends of the resilient component 13 to abut against the first abutting portion 112 and the second fitting portion 121 respectively (as shown in FIG. 17). As a result, when the second object 20 is stretched, the second object 20 and the third object 30 undergo rotational movement. Therefore, the present disclosure further meets practical operation needs.

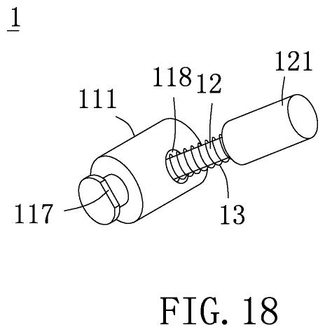

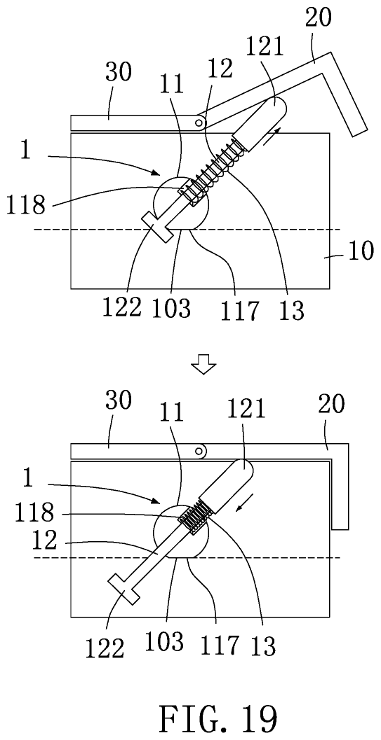

Referring to FIG. 18 through FIG. 20, this embodiment is distinguished from the aforesaid embodiment by the technical feature described below. The fitting member 11 and the rod member 12 are laterally movably fitted together. The fitting member 11 has a positioning portion 117 for positioning the angle or movement angle of the fitting member 11 and the rod member 12. The fitting member 11 laterally (or vertically) has a mounting portion 118. The rod member 12 is mounted on the mounting portion 118 in order to move or retract. The two ends of the resilient component 13 abut against the mounting portion 118 of the fitting member 11 and the second fitting portion 121 of the rod member 12, respectively. The mounting portion 118 is a hole portion, pipe portion, slot portion, groove portion, barrel portion, cylinder portion, step portion or dent portion.

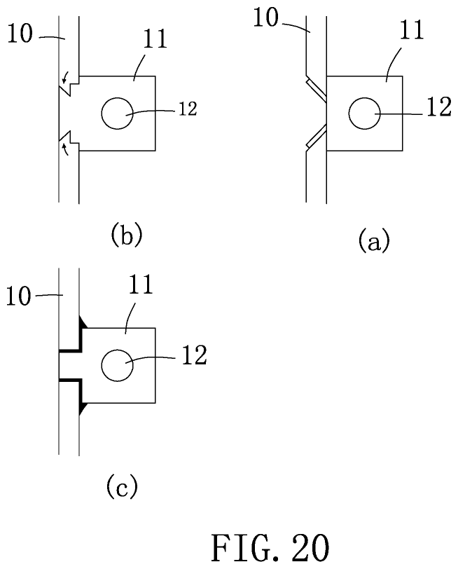

To start working, the positioning portion 117 of the fitting member 11 of the stretchable rod structure 1 is fitted to the corresponding positioning portion 103 of the first object 10, such that the positioning portion 117 and the corresponding positioning portion 103 prevent rotation of each other or limit displacement of each other. Therefore, the fitting member 11 and the first object 10 are fitted together vertically or substantially vertically. The rod member 12 is parallel or substantially parallel to the first object 10. The second fitting portion 121 of the rod member 12 abuts against the second object 20. The second object 20 is movably fitted to the third object 30. Alternatively, the first fitting portion 111 of the fitting member 11 is fitted to the first object 10 by expanded connection (portion a of FIG. 20), by riveting (portion b of FIG. 20), or by welding (portion c of FIG. 20), such that the fitting member 11 is vertically or substantially vertically fitted to the first object 10, whereas the rod member 12 is parallel or substantially parallel to the first object 10.

When the stretchable rod structure is in operation and in use, no force is applied to the second object 20, thereby causing the resilient component 13 to be resiliently released and capable of pushing the rod member 12, enabling the first abutting portion 112 and the second abutting portion 122 to attain abutting, and enabling the rod member 12 to drive the second object 20 to move away from the first object 10. When an applied force is applied to the second object 20, the second object 20 moves toward the first object 10 and compresses the resilient component 13; meanwhile, the fitting member 11 is stationary, such that the second object 20 drives the rod member 12 to move within the fitting member 11. Therefore, when the second object 20 is stretched, the second object 20 and the third object 30 undergo rotational movement. Therefore, the stretchable rod structure 1 is fitted to the first object 10 and the second object 20, allowing two objects to fit together, move or separate.

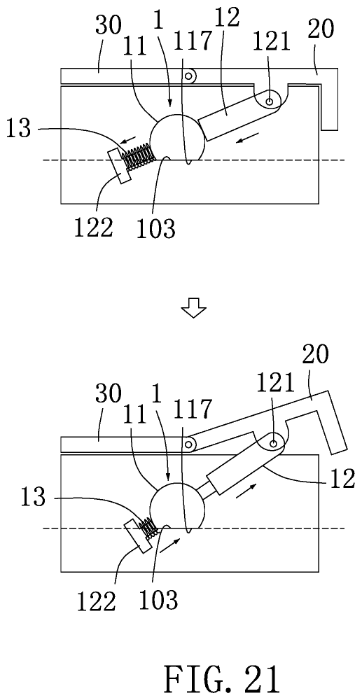

Referring to FIG. 21, this embodiment is distinguished from the aforesaid embodiment by the technical feature described below. The positioning portion 117 of the fitting member 11 of the stretchable rod structure 1 is fitted to the corresponding positioning portion 103 of the first object 10, such that the positioning portion 117 and the corresponding positioning portion 103 prevent rotation of each other or limit displacement of each other. As a result, the fitting member 11 is vertically or substantially vertically fitted to the first object 10, whereas the rod member 12 is parallel or substantially parallel to the first object 10, allowing the second fitting portion 121 of the rod member 12 to be movably pivotally connected to the second object 20, allowing the second object 20 to be movably fitted to the third object 30, and allowing the two ends of the resilient component 13 to abut against the fitting member 11 and the second abutting portion 122 of the rod member 12, respectively.

To start working, an applied force is applied to the second object 20 to cause the second object 20 to move away from the first object 10 and compress the resilient component 13; meanwhile, the fitting member 11 is stationary, such that the second object 20 drives the rod member 12 to move within the fitting member 11. Thus, when the second object 20 is stretched, the second object 20 and the third object 30 undergo rotational movement. When the fitting member 11 moves to a predetermined position, the first abutting portion 112 and the second abutting portion 122 together attain abutting When applied forces are no longer applied to the second object 20, the resilient component 13 is released and drives the rod member 12, such that the rod member 12 drives the second object 20 to move toward the first object 10. Therefore, the stretchable rod structure 1 is fitted to the first object 10 and the second object 20, allowing two objects to fit together, move or separate.

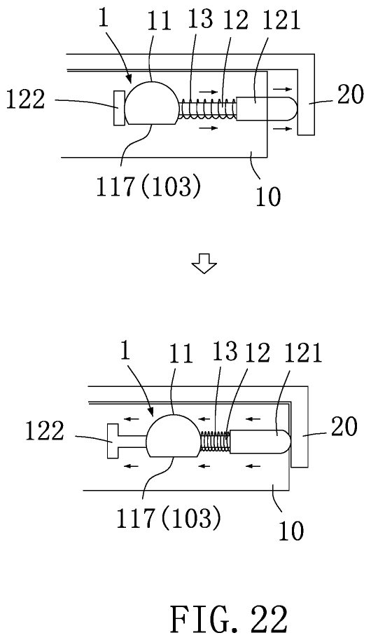

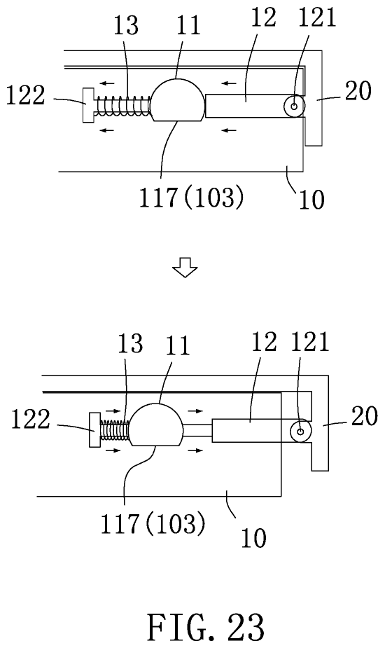

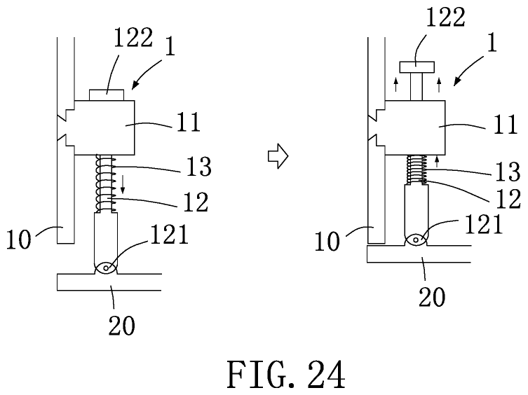

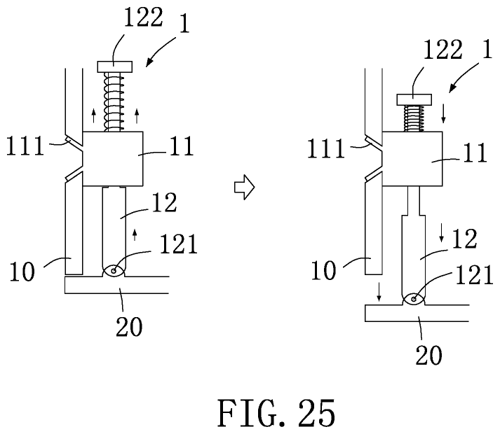

Referring to FIG. 22 through FIG. 25, this embodiment is distinguished from the aforesaid embodiment by the technical feature described below. The positioning portion 117 of the fitting member 11 of the stretchable rod structure 1 is fitted to the corresponding positioning portion 103 of the first object 10, such that the positioning portion 117 and the corresponding positioning portion 103 prevent rotation of each other or limit displacement of each other (as shown in FIG. 22, FIG. 23). Alternatively, the first fitting portion 111 of the fitting member 11 is fitted to the first object 10 by riveting (as shown in FIG. 24) or by expanded connection (as shown in FIG. 25), such that the fitting member 11 is vertically or substantially vertically fitted to the first object 10, whereas the rod member 12 is parallel or substantially parallel to the first object 10, allowing the second fitting portion 121 of the rod member 12 to abut against the second object 20 (as shown in FIG. 22), or allowing the second fitting portion 121 of the rod member 12 to movably pivotally connect to the second object 20 (as shown in FIG. 23 through FIG. 25), and allowing the two ends of the resilient component 13 to abut against the fitting member 11 and second fitting portion 121 of the rod member 12 respectively (as shown in FIG. 22, FIG. 24), or allowing the two ends of the resilient component 13 to abut against the fitting member 11 and the second abutting portion 122 of the rod member 12 respectively (as shown in FIG. 23, FIG. 25). Therefore, the present disclosure further meets practical operation needs.

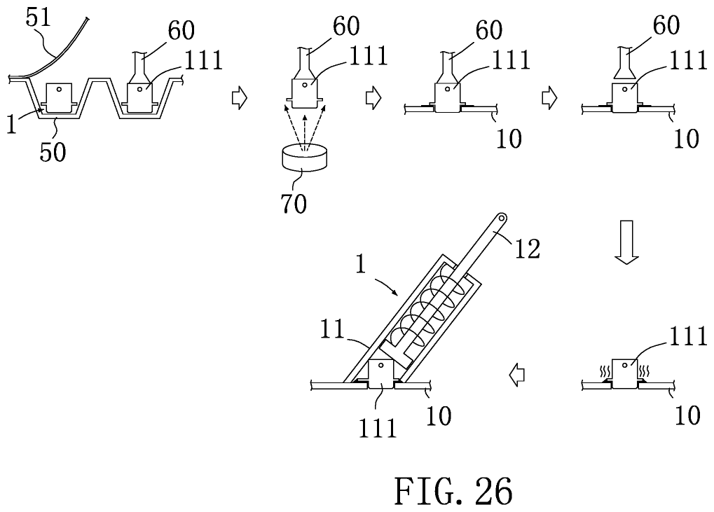

Referring to FIG. 26, the present disclosure provides a stretchable rod structure and a method of mounting a stretchable rod structure on an object. The method comprises lifting first fitting portion 111 out of a carrier 50 with a tool 60, comparing, with a comparison device 70, the first fitting portion 111 with a first object 10 to identify a position thereof, placing the first fitting portion 111 on the first object 10 with the tool 60, welding, riveting, expandedly connecting or fastening the first fitting portion 111 to the first object 10, then fitting to the first fitting portion 111 both a fitting member 11 and a rod member 12 which are capable of movably fitting, thereby forming the stretchable rod structure 1.

In an embodiment of the present disclosure, the carrier 50 has a cover member 51 adapted to be sealedly disposed at the stretchable rod structure 1 on the carrier 50.

In an embodiment of the present disclosure, the tool 60 releases the first fitting portion 111 at a predetermined height, such that the first fitting portion 111 falls onto the first object 10. The predetermined height ranges from 0.001 mm to 50 mm. Therefore, the present disclosure further meets practical assembly needs and usage needs.

In an embodiment of the present disclosure, the tool 60 is a vacuum extractor, clamp, fastener, sucker or magnetic extractor. Therefore, the present disclosure further meets practical assembly needs and usage needs.

In an embodiment of the present disclosure, the comparison device 70 is an image comparison device, position comparison device, automatic comparison device or visual comparison device. Therefore, the present disclosure further meets practical assembly needs and usage needs.

In another embodiment of the present disclosure, after the stretchable rod structure 1 or the first fitting portion 111 has been lifted with the tool 60, the positions of the stretchable rod structure 1 or the first fitting portion 111 and the first object 10 are compared by means of the comparison device 70, and then the stretchable rod structure 1 or the first fitting portion 111 is placed on the first object 10 with the tool 60 and then welded, riveted, expandedly connected or fastened to the first object 10. The stretchable rod structure 1 has the fitting member 113 and rod member 12 which are capable of movable fitting. Therefore, the present disclosure further meets practical assembly needs and usage needs.

In another embodiment of the present disclosure, after the stretchable rod structure 1 or the first fitting portion 111 has been lifted with the tool 60, the stretchable rod structure 1 or the first fitting portion 111 is placed on the first object 10 with the tool 60 and then welded, riveted, expandedly connected or fastened to the first object 10. Therefore, the present disclosure further meets practical assembly needs and usage needs.

In conclusion, an object of the present disclosure is to provide a stretchable rod structure and a method of mounting the same on an object, such that the stretchable rod structure is fitted to a first object and a second object, allowing two objects to fit together, move or separate.

While the present disclosure has been described by means of specific embodiments, numerous modifications and variations could be made thereto by those skilled in the art without departing from the scope and spirit of the present disclosure set forth in the claims.

What is claimed is:

1. A stretchable rod structure, comprising:
a fitting member having a first fitting portion or a first abutting portion; and
a rod member movably fitted to the fitting member and having a second fitting portion or a second abutting portion.

2. The stretchable rod structure of claim 1, characterized in the first fitting portion or the first abutting portion is adapted to fit to or abut against a first object; or the second fitting portion or the second abutting portion is adapted to fit to or abut against a second object.

3. The stretchable rod structure of claim 1, further comprising a resilient component with two ends abutting against the fitting member and the rod member, respectively, or against the first fitting portion and the fitting member or the rod member, respectively.

4. The stretchable rod structure of claim 2, characterized in that a first angle and a second angle are defined between the fitting member and the first object, with the first angle being greater than the second angle, such that the stretchable rod structure moves obliquely to stretch.

5. The stretchable rod structure of claim 2, characterized in that the fitting member fits to the first object, whereas the rod member fits to or abuts against the second object, with the second object being movably fitted to a third object, such that the second object and the third object undergo rotational movement when the second object is stretched.

6. The stretchable rod structure of claim 1, characterized in that the fitting member has a non-right-angle fitting surface so as to be fitted to the first fitting portion.

7. The stretchable rod structure of claim 6, characterized in that two edges of the non-right-angle fitting surface have a first angle and a second angle, respectively, with the first angle being greater than the second angle.

8. The stretchable rod structure of claim 2, characterized in that the fitting member has a non-right-angle fitting surface adapted to be fitted to the first object.

9. The stretchable rod structure of claim 8, characterized in that two edges of the non-right-angle fitting surface have a first angle and a second angle, respectively, the first angle being greater than the second angle.

10. The stretchable rod structure of claim 2, characterized in that the first object has a fitting portion, and the fitting portion of the first object is fitted to the first fitting portion of the fitting member through the fitting member.

11. The stretchable rod structure of claim 1, characterized in that the fitting member is laterally movably fitted to the rod member.

12. The stretchable rod structure of claim 2, characterized in that the fitting member is laterally movably fitted to the rod member, and the rod member is parallel or substantially parallel to the first object.

13. The stretchable rod structure of claim 2, characterized in that the fitting member is laterally movably fitted to the rod member, wherein the fitting member and the first object are fitted together vertically or substantially vertically.

14. The stretchable rod structure of claim 1, characterized in that the fitting member has a positioning portion for positioning an angle or a movement angle of the fitting member or the rod member.

15. The stretchable rod structure of claim 2, characterized in that the fitting member has a positioning portion, and the first object has a corresponding positioning portion, the positioning portion and the corresponding positioning portion prevent rotation of each other or limit displacement of each other.

16. The stretchable rod structure of claim 1, characterized in that the fitting member has a mounting portion aligned vertically or laterally, and the rod member is mounted on the mounting portion to undergo movement or retraction.

17. A method of mounting a stretchable rod structure on an object, the method comprising: lifting a first fitting portion out of a carrier with a tool, comparing, with a comparison device, the first fitting portion with a first object to identify a position thereof, placing the first fitting portion on the first object with the tool, welding, riveting, expandedly connecting or fastening the first fitting portion to the first object, then fitting to the first fitting portion both a fitting member and a rod member which are capable of movably fitting.

18. A method of mounting a stretchable rod structure on an object, the method comprising: lifting the stretchable rod structure or a first fitting portion thereof with a tool, comparing, with a comparison device, the stretchable rod structure or the first fitting portion with a first object to identify a position thereof, and placing the stretchable rod structure or the first fitting portion on the first object with the tool so as to weld, rivet, expandedly connect or fasten the stretchable rod structure or the first fitting portion to the first object, wherein the stretchable rod structure has a fitting member and a rod member which are adapted for movably fitting.

19. A method of mounting a stretchable rod structure on an object, the method comprising: lifting the stretchable rod structure or a first fitting portion thereof with a tool, placing the stretchable rod structure or the first fitting portion on the first object with the tool so as to weld, rivet, expandedly connect or fasten the stretchable rod structure or the first fitting portion to the first object, wherein the stretchable rod structure has a fitting member and a rod member which are adapted for movably fitting.
